(19) United States
(12) Patent Application Publication
(10) Pub. No.: US 2024/0277186 A1
(43) Pub. Date: Aug. 22, 2024

(54) SYSTEMS FOR LOCATING A MOTOR IN STAND MIXERS

(71) Applicant: Haier US Appliance Solutions, Inc., Wilmington, DE (US)

(72) Inventors: Andrew Pierce, Louisville, KY (US); Edward Simeon Chupka, Bardstown, KY (US)

(21) Appl. No.: 18/170,339

(22) Filed: Feb. 16, 2023

(51) Int. Cl. A47J 43/08

(52) U.S. Cl. CPC A47J 43/082; A47J 2043/04454

(57) ABSTRACT

A stand mixer appliance includes a casing that includes a base, a column mounted to the base, and a motor housing mounted to the column that extends outwardly above the base. A motor is positioned within the motor housing. The motor includes three pins. The motor housing includes a first portion and a second portion. The second portion includes three slots where one of the three slots is elongated along a transverse direction of the motor, and the other two of the three slots are elongated along a lateral direction of the motor. The three pins of the motor extend perpendicular to the transverse direction, and each of the three pins of the motor are disposed within a respective one of the three slots of the second portion of the motor housing.

### FIELD OF THE INVENTION

The present subject matter relates generally to locating systems in stand mixers, particularly for locating a motor.

### BACKGROUND OF THE INVENTION

Stand mixers are generally used for performing automated mixing, churning, or kneading involved in food preparation. Typically, stand mixers include a motor configured to provide torque to one or more driveshafts. Users may connect various utensils to the one or more driveshafts, including whisks, spatulas, or the like. In stand mixers, the housing for the motor is conventionally created in two parts for assembly. Critical to the function and craftsmanship of the stand mixer, all output shafts need to be concentric with openings in the housing for the motor. In current practice, holes and pins and patterns of fasteners are used to locate the motor in the housing, which can require precise tooling, part checking, or oversized holes resulting in increased costs as well as variation and misalignment of the motor.

### BRIEF DESCRIPTION OF THE INVENTION

Aspects and advantages of the invention will be set forth in part in the following description, or may be apparent from the description, or may be learned through practice of the invention.

In one example embodiment, a stand mixer appliance includes a casing that includes a base, a column mounted to the base, and a motor housing mounted to the column that extends outwardly above the base. A motor is positioned within the motor housing. The motor includes three pins. The motor housing includes a first portion and a second portion. The second portion includes three slots, where one of the three slots is elongated along a transverse direction, and the other two of the three slots are elongated along a lateral direction that is perpendicular to the transverse direction. The three pins of the motor extend perpendicular to the transverse and lateral directions. Each of the three pins of the motor are disposed within a respective one of the three slots of the second portion of the motor housing.

In another example embodiment, a stand mixer appliance includes a casing that includes a base, a column mounted to the base, and a motor housing mounted to the column that extends outwardly above the base. A motor is positioned within the motor housing. The motor includes three pins. Further, the stand mixer appliance includes a horizontal output shaft rotatable by the motor relative to the motor housing. The motor housing includes a first portion and a second portion. The second portion includes three slots where one of the three slots is elongated along a transverse direction of the motor, and the other two of the three slots elongated along a lateral direction that is perpendicular to the transverse direction. The three pins of the motor extend perpendicular to the transverse and lateral directions. Each of the three pins of the motor are disposed within a respective one of the three slots of the second portion of the motor housing.

In another example embodiment, a stand mixer appliance includes a casing that includes a base, a column mounted to the base, and a motor housing mounted to the column that extends outwardly above the base. A motor is positioned within the motor housing. The motor includes at least three pins. Further, the stand mixer appliance includes a horizontal output shaft rotatable by the motor relative to the motor housing. The motor housing includes a first portion and a second portion. The second portion includes at least three slots, where one of the at least three slots is elongated along a transverse direction of the motor, and the other two of the at least three slots elongated along a lateral direction that is perpendicular to the transverse direction.

The three pins of the motor extend perpendicular to the transverse direction. Each of the three pins of the motor are disposed within a respective slot of the at least three slots of the second portion of the motor housing.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 illustrates a side section view of a stand mixer according to an example embodiment of the present disclosure.

FIG. 2 illustrates a perspective view of a motor housing of the example stand mixer of FIG. 1.

FIG. 3 illustrates a perspective view of a motor in the motor housing of FIG. 2.

FIG. 4 illustrates a bottom perspective view of a portion of the motor housing of FIG. 2.

FIG. 5 illustrates a front perspective view of the motor housing of FIG. 2.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “includes” and “including” are intended to be inclusive in a manner similar to the term “comprising.” Similarly, the term “or” is generally intended to be inclusive (i.e., “A or B” is intended to mean “A or B or both”). Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a ten percent (10%) margin.

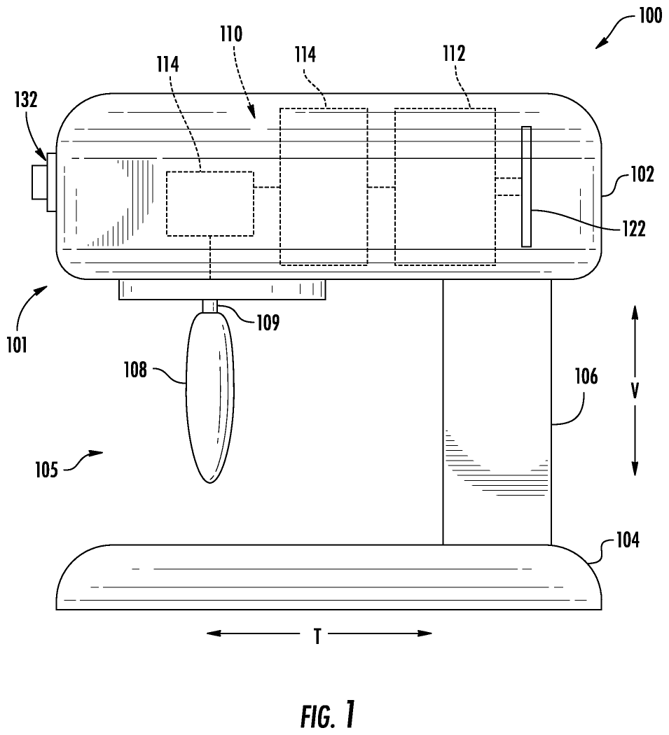

FIG. 1 provides a side, elevation view of a stand mixer 100 according to an example embodiment of the present subject matter. It will be understood that stand mixer 100 is provided by way of example only and that the present subject matter may be used in or with any suitable stand mixer in alternative example embodiments. Moreover, stand mixer 100 of FIG. 1 defines a vertical direction V and a transverse direction T, which are perpendicular to each other. It should be understood that these directions are presented for example purposes only, and that relative positions and locations of certain aspects of stand mixer 100 may vary according to specific embodiments, spatial placement, or the like.

Stand mixer 100 may include a casing 101. In detail, casing 101 may include a motor housing 102, a base 104, and a column 106. Motor housing 102 may house various mechanical and/or electrical components of stand mixer 100, which will be described in further detail below. For example, as shown in FIG. 1, a motor 112, a reduction gearbox 114, and a bevel gearbox 116 may be disposed within motor housing 102. Base 104 may support motor housing 102. For example, motor housing 102 may be mounted (e.g., pivotally) to base 104 via column 106, e.g., that extends upwardly (e.g., along the vertical direction V) from base 104. Motor housing 102 may be suspended over a mixing zone 105, within which a mixing bowl may be disposed and/or mounted to base 104.

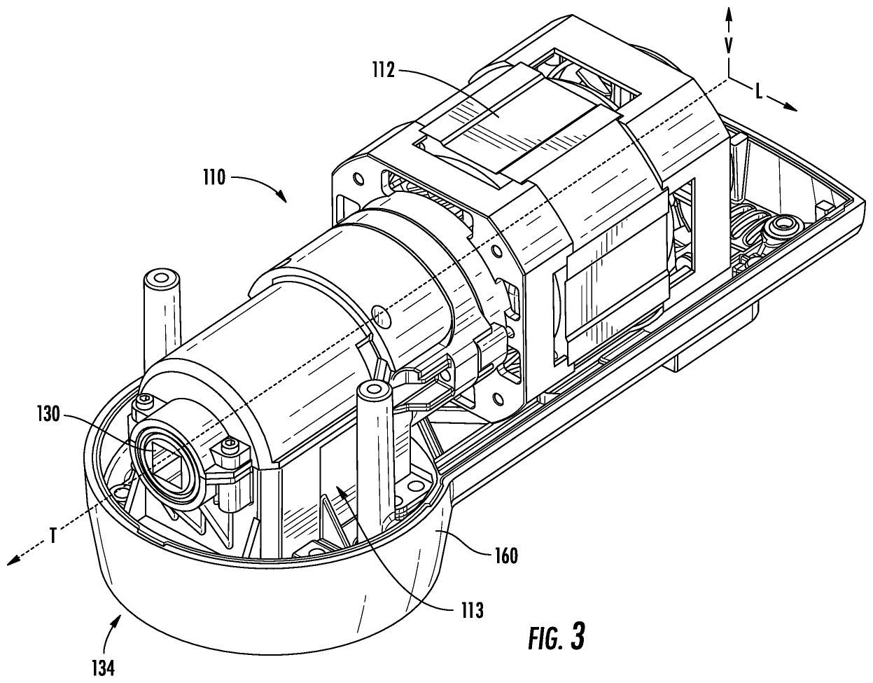

A drivetrain 110 may be provided within motor housing 102 and is configured for coupling motor 112 to a shaft 109 (e.g., a mixer shaft), such that shaft 109 is rotatable via motor 112 through drivetrain 110. Drivetrain 110 may include planetary gearbox 114, bevel gearbox 116, etc. An opening 132 for a horizontal output shaft 130 (FIG. 3) may align with the rotational axis of motor 112. Mixer shaft 109 may be positioned above mixing zone 105 on motor housing 102, and an attachment 108, such as a beater, whisk, or hook, may be removably mounted to mixer shaft 109. Attachment 108 may rotate within a bowl (not shown) in mixing zone 105 to beat, whisk, knead, etc. material within the bowl during operation of motor 112.

As noted above, motor 112 may be operable to rotate mixer shaft 109. Motor 112 may be a direct current (DC) motor in certain example embodiments. In alternative example embodiments, motor 112 may be an alternating current (AC) motor. Motor 112 may include a rotor and a stator. The stator may be mounted within motor housing 102 such that the stator is fixed relative to motor housing 102, and the rotor may be coupled to mixer shaft 109 via drivetrain 110. A current through windings within the stator may generate a magnetic field that induces rotation of the rotor, e.g., due to magnets or a magnetic field via coils on the stator. The rotor may rotate at a relatively high rotational velocity and relatively low torque. Thus, drivetrain 110 may be configured to provide a rotational speed reduction and mechanical advantage between motor 112 and mixer shaft 109.

Stand mixer 100 may include a controller 122 provided within casing 101. For example, controller 122 may be located within motor housing 102 of casing 101. Controller 122 may be a microcontroller, as would be understood, including one or more processing devices, memory devices, or controllers. Controller 122 may include a plurality of electrical components configured to permit operation of stand mixer 100 and various components therein (e.g., motor 112). For instance, controller 122 may be a printable circuit board (PCB), as would be well known.

As used herein, the terms “control board,” “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 122 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 122 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

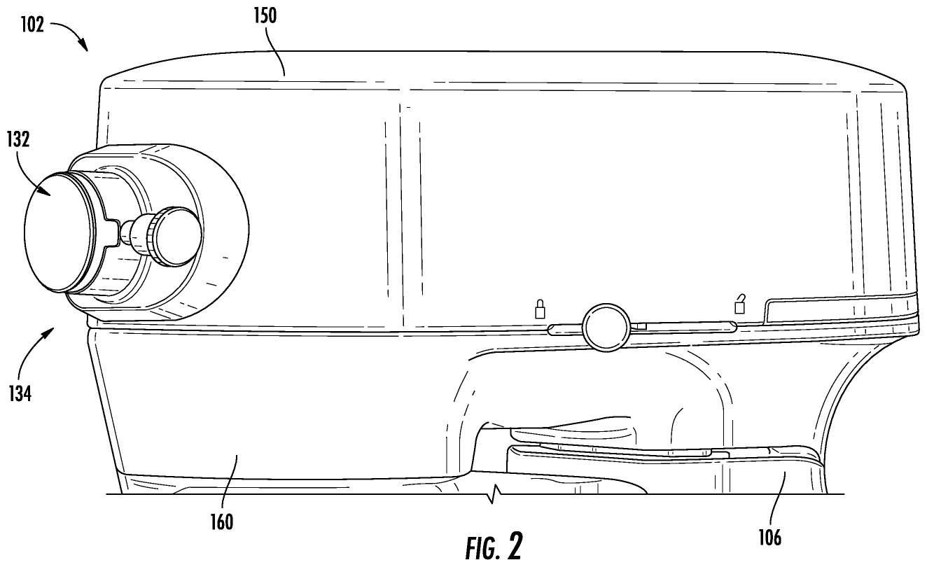

FIG. 2 illustrates a perspective view of motor housing 102. As shown, motor housing 102 may include a first portion 150 and a second portion 160. Thus, e.g., motor housing 102 may include a two-piece structure that collectively forms motor housing 102. Moreover, first portion 150 may couple to second portion 160 to form motor housing 102. Second portion 160 may be mounted, e.g., pivotally, to column 106. As stated above, an opening 132 for a horizontal output shaft 130 (FIG. 3) may be defined by motor housing 102. Opening 132 may be positioned on a front portion 134 of motor housing 102 for easy access for an operator.

FIG. 3 illustrates second portion 160 of motor housing 102 with motor 112 and a motor assembly 113 shown. Motor assembly 113 may include components of drivetrain 110, e.g., planetary gearbox 114, bevel gearbox 116, and horizontal output shaft 130. Motor assembly 113 may be mounted within second portion 160 such that the axis of rotation of the motor is axially aligned with the transverse direction T. Additionally, motor assembly 113 may be mounted within second portion 160 such that horizontal output shaft 130 is positioned proximate front portion 134.

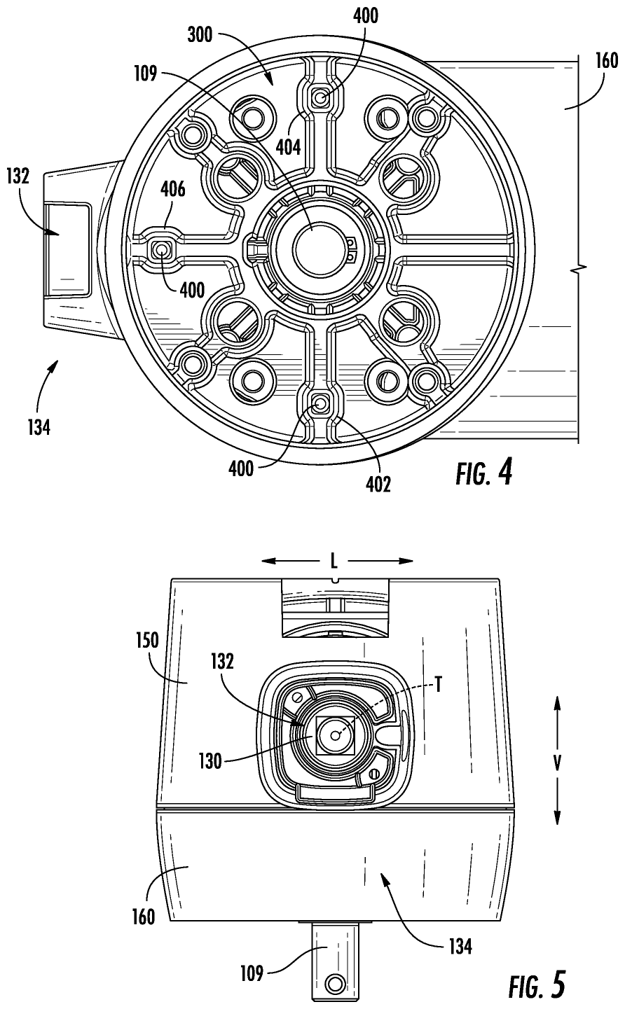

FIG. 4 illustrates a perspective view of a bottom portion 300 of second portion 160 above mixing zone 105. Pins 400 may extend from motor assembly 113, e.g., from a portion of motor assembly 113 housing bevel gearbox 116. Pins 400 may be spaced apart on motor assembly 113, e.g., two pins of pins 400 may be spaced along the lateral direction L and one pin of pins 400 may be spaced along the transverse direction T perpendicular to the laterally spaced pins 400. In example embodiments, pins 400 may be positioned about the rotational axis of mixer shaft 109, e.g., two pins of pins 400 may be spaced along the lateral direction L and one pin of pins 400 may be spaced along the transverse direction T from the rotational axis of mixer shaft 109. In the illustrated example embodiment of FIG. 4, motor assembly 113 includes three pins 400. The two pins of pins 400 spaced along the lateral direction L may be spaced at least four centimeters (4 cm) apart for increased motor 112 stability than a scenario with pins 400 closer than four centimeters (4 cm). The one pin of pins 400 spaced along the transverse direction T may be at least two centimeters (2 cm) from the rotational axis of mixer shaft 109. Pins 400 may extend in the vertical direction V from motor assembly 113, e.g., perpendicular to both the transverse direction T and the lateral direction L. The pins 400 may be shaped as cylindrical pins, tapered pins, or rounded pins in certain example embodiments.

Referring still to FIG. 4, second portion 160 of motor housing 102 may have at least three slots 402, 404, and 406 positioned at bottom portion 300. Slots 402, 404, and 406 may be spaced apart on second portion 160 of motor housing 102, e.g., slots 402, 404 may be spaced along the lateral direction L and slot 406 may be spaced along the transverse direction T perpendicular to the laterally spaced slots 402, 404. In example embodiments, slots 402, 404, and 406 may be positioned about the rotational axis of mixer shaft 109, e.g., slots 402, 404 may be spaced along the lateral direction L and slot 406 may be spaced along the transverse direction T from the rotational axis of mixer shaft 109. Slot 406 may be positioned closer to front portion 134 than slots 402, 404, e.g., along the transverse direction T. In the illustrated example embodiment of FIG. 4, motor assembly 113 includes three slots 402, 404, and 406. The two slots 402, 404 spaced along the lateral direction L may be spaced at least four centimeters (4 cm) apart for increased motor 112 stability than a scenario with slots 402, 404 closer than four centimeters (4 cm). The slot 406 spaced along the transverse direction T may be at least two centimeters (2 cm) from the rotational axis of mixer shaft 109.

Pins 400 may be configured to engage with slots 402, 404, and 406 in order to locate motor 112 in second portion 160. Each of pins 400 engaging with each respective slots 402, 404, and 406 act as two-way (2-way) locators, e.g., two-way (2-way) locators prevent rotation, and each two-way locator acting together prevents both rotation and translation of the motor assembly 113. In the illustrated example embodiment of FIG. 4, the pin 400 engaging in slot 406 may be the two-way (2-way) locator, e.g., restrains rotation in a horizontal plane of motor 112 relative to second portion 160. The pins 400 engaging in slots 402, 404 may also be two-way (2-way) locators, e.g., restrains rotation and translation in the horizontal plane of motor 112 relative to second portion 160. Pin 400 in slot 406 may be two-way locators acting to prevent rotation of the motor assembly 113. Thus, locating motor assembly 113 to second portion 160 with pins 400 engaging in slots 402, 404, and 406 may advantageously properly align horizontal output shaft 130 of motor assembly 113 with opening 132. Additionally, locating motor assembly 113 to second portion 160 with pins 400 engaging in slots 402, 404, and 406 may advantageously properly align mixer shaft 109.

As illustrated in FIG. 5, with pins 400 engaging with slots 402, 404, and 406, horizontal output shaft 130 of motor assembly 113 may align with opening 132 for easy access by an operator. Ensuring horizontal output shaft 130 is concentric, with respect the transverse direction T, with opening 132 of motor housing 102 ensures that a wide range of accessories may be attached to stand mixer 100, including attachments from different manufactures. Ensuring that slots 402, 404 are in line, with respect to the lateral direction L, perpendicular with horizontal output shaft 130, and ensuring that slot 406 is in line, with respect to the transverse direction T with the rotational axis of mixer shaft 109, reduces the number of variations in slot placement that may affect the alignment of horizontal output shaft 130 and opening 132.

For example, if two slots are used, instead of three slots 402, 404, and 406, the angular offset, the distance between them, and the location relative to the center line may all affect the alignment. The three slots 402, 404, and 406 arrangement removes the variation from distance between the features and reduces the geometric leverage by positioning two of the two-way (2-way) locators, e.g., slots 402, 404, farther away from the rotational axis of mixer shaft 109, while in line with respect to the lateral direction L. In other words, along the lateral direction L, the distance between slot 402, 404 may be larger than the distance between slot 406 and the rotational axis of mixer shaft 109.

As may be seen from the above, the use of locating features, such as pins 400 with slots 402, 404, and 406 may locate motor 112 in motor housing 102 such that horizontal output shaft 130 is properly aligned with opening 132. When horizontal output shaft 130 is concentric, with respect the transverse direction, with opening 132 of motor housing 102, a wide range of accessories may be attached to stand mixer 100. The wide range of accessories may include attachments from different manufactures. In addition, pins 400 engaging with slots 402, 404, and 406 may ease the assembly of stand mixer 100, e.g., as a result of positively aligning horizontal output shaft 130 to opening 132 each time. Further, results of the proper alignment of horizontal output shaft 130 to opening 132 may be improved craftsmanship, increased performance, and reduced assembly problems.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A stand mixer appliance, comprising:
a casing that comprises a base, a column mounted to the base, and a motor housing mounted to the column and extending outwardly above the base; and
a motor positioned within the motor housing, the motor comprising three pins,
wherein the motor housing comprises a first portion and a second portion, the second portion comprising three slots, one of the three slots elongated along a transverse direction, the other two of the three slots elongated along a lateral direction that is perpendicular to the transverse direction, the three pins of the motor extending perpendicular to the transverse and lateral directions, each of the three pins of the motor disposed within a respective one of the three slots of the second portion of the motor housing.

2. The stand mixer of claim 1, wherein one of the three pins of the motor in the slot of the second portion elongated along the transverse direction restrains translation of the motor relative to the second portion in a plane perpendicular to a vertical direction that is perpendicular to both of the transverse and lateral directions.

3. The stand mixer of claim 1, wherein two of the three pins of the motor in the two slots of the second portion elongated along the lateral direction restrains rotation and translation of the motor relative to the second portion in a plane perpendicular to a vertical direction that is perpendicular to both of the transverse and lateral directions.

4. The stand mixer of claim 1, further comprising a horizontal output shaft rotatably mounted to the motor housing, the three pins of the motor disposed within the three slots of the second portion arranged and oriented to align the motor with the horizontal output shaft.

5. The stand mixer of claim 1, wherein the two of the three slots that are elongated along the lateral direction are spaced by no less than four centimeters from each other in the lateral direction.

6. The stand mixer of claim 1, wherein the three pins are one of cylindrical pins, tapered pins, and rounded pins.

7. A stand mixer appliance, comprising:
a casing that comprises a base, a column mounted to the base, and a motor housing mounted to the column and extending outwardly above the base;
a motor positioned within the motor housing, the motor comprising three pins; and
a horizontal output shaft rotatable by the motor relative to the motor housing,
wherein the motor housing comprises a first portion and a second portion, the second portion comprising three slots, one of the three slots elongated along a transverse direction, the other two of the three slots elongated along a lateral direction that is perpendicular to the transverse direction, the three pins of the motor extending perpendicular to the transverse and lateral directions, each of the three pins of the motor disposed within a respective one of the three slots of the second portion of the motor housing.

8. The stand mixer of claim 7, wherein one of the three pins of the motor in the slot of the second portion elongated along the transverse direction restrains translation of the motor relative to the second portion in a plane perpendicular to a vertical direction that is perpendicular to both of the transverse and lateral directions.

9. The stand mixer of claim 7, wherein two of the three pins of the motor in the two slots of the second portion elongated along the lateral direction restrains rotation and translation of the motor relative to the second portion in a plane perpendicular to a vertical direction that is perpendicular to both of the transverse and lateral directions.

10. The stand mixer of claim 7, further comprising a horizontal output shaft rotatably mounted to the motor housing, the three pins of the motor disposed within the three slots of the second portion arranged and oriented to align the motor with the horizontal output shaft.

11. The stand mixer of claim 7, wherein the two of the three slots that are elongated along the lateral direction are spaced by no less than four centimeters from each other in the lateral direction.

12. The stand mixer of claim 7, wherein the three pins are one of cylindrical pins, tapered pins, and rounded pins.

13. A stand mixer appliance, comprising:
a casing that comprises a base, a column mounted to the base, and a motor housing mounted to the column and extending outwardly above the base;
a motor mounted within the motor housing, the motor comprising at least three pins; and
a horizontal output shaft rotatable by the motor relative to the motor housing,
wherein the motor housing comprises a first portion and a second portion, the second portion comprising at least three slots, one of the at least three slots elongated along a transverse direction, the other two of the at least three slots elongated along a lateral direction that is perpendicular to the transverse direction, the three pins of the motor extending perpendicular to the transverse direction, each of the three pins of the motor disposed within a respective slot of the at least three slots of the second portion of the motor housing.

14. The stand mixer of claim 13, wherein one of the three pins of the motor in the slot of the second portion elongated along the transverse direction restrains translation of the motor relative to the second portion in a plane perpendicular to a vertical direction that is perpendicular to both of the transverse and lateral directions.

15. The stand mixer of claim 13, wherein two of the three pins of the motor in the two slots of the second portion elongated along the lateral direction restrains rotation and translation of the motor relative to the second portion in a plane perpendicular to a vertical direction that is perpendicular to both of the transverse and lateral directions.

16. The stand mixer of claim 13, further comprising a horizontal output shaft rotatably mounted to the motor housing, the at least three pins of the motor disposed within the at least three slots of the second portion arranged and oriented to align the motor with the horizontal output shaft.

17. The stand mixer of claim 13, wherein the two of the three slots that are elongated along the lateral direction are spaced by no less than four centimeters from each other in the lateral direction.

18. The stand mixer of claim 13, wherein the three pins are one of cylindrical pins, tapered pins, and rounded pins.
